(19) United States
(12) Patent Application Publication
(10) Pub. No.: US 2018/0173694 A1
(43) Pub. Date: Jun. 21, 2018

(54) METHODS AND COMPUTER SYSTEMS FOR NAMED ENTITY VERIFICATION, NAMED ENTITY VERIFICATION MODEL TRAINING, AND PHRASE EXPANSION

(71) Applicant: Industrial Technology Research Institute, Hsinchu (TW)

(72) Inventors: Chao-Hong Liu, Taoyuan City (TW); Tzi-Cker Chiueh, Taipei City (TW); Chih-Chung Kuo, Hsinchu County (TW); Chung-Han Lee, Tainan City (TW); Jian-Yung Hung, Taipei City (TW)

(73) Assignee: Industrial Technology Research Institute, Hsinchu (TW)

(21) Appl. No.: 15/653,536

(22) Filed: Jul. 19, 2017

(30) Foreign Application Priority Data
Dec. 21, 2016 (TW) 105142572

(51) Int. Cl. G06F 17/27; G06F 17/30; G06N 99/00

(52) U.S. Cl. CPC G06F 17/278; G06N 99/005; G06F 17/30672

(57) ABSTRACT

The disclosure provides methods and computer systems for named entity verification, named entity verification model training, and phrase expansion. The method for named entity verification includes to receive an unknown type phrase, to generate a query phrase according to the unknown type phrase, to perform auto-completion on the query phrase to receive one or more returned phrases, to extract feature information from the returned phrases, and to determine a named entity type of the unknown type phrase based on the feature information verify whether or not the unknown type phrase belongs to the target named entity type based on the feature information and a target verification model to accordingly output a verification result.

### CROSS-REFERENCE TO RELATED APPLICATION

This application claims the priority benefit of Taiwan application serial no. 105142572, filed on Dec. 21, 2016. The entirety of the above-mentioned patent application is hereby incorporated by reference herein and made a part of this specification.

### TECHNICAL FIELD

The disclosure relates to techniques for named entity verification, named entity verification model training, and phrase expansion.

### BACKGROUND

Named entity recognition is subtask of information extraction that aims to identify and classify words in text into predefined categories such as personal names, locations, organizations, time expressions, monetary values, and etc. The recognition results may then be used for various downstream purposes such as questioning and answering, automatic forwarding, information retrieval, document and news searching, and many others.

Many of the existing named entity recognition solutions would extensively rely on human involvement in pre-tagging named entities in a training text corpus, and thus named entity recognition may not be available without a tagged text corpus. In real application scenario, when the user merely provides few phrases or short sentences for named entity recognition, the existing solutions where a text corpus is a necessity may not be the suitable tools. Such customized products may require long-term development and may be less adaptive to new phrases. A tremendous amount of webpages or text corpora may be collected to crawl for new phrases in every certain type of named entities, and more human involvement may be unavoidable. This may create costly and time-consuming burden for the developers.

Moreover, the existing solutions may only identify named entities based on language-dependent contextual information and may not be able to handle multilingual texts. Hence, the products available today may only be used with regional restrictions due to different languages used in various geographical regions or countries and may thus hardly promoted on a global scale.

### SUMMARY OF THE DISCLOSURE

Accordingly, the disclosure is directed to methods and computer systems for named entity verification, named entity verification model training, and phrase expansion.

According to one of the exemplary embodiments, the method for named entity verification includes to receive an unknown type phrase, to generate a query phrase according to the unknown type phrase, to perform auto-completion on the query phrase to receive one or more returned phrases, to extract feature information from the returned phrases, and to determine a named entity type of the unknown type phrase based on the feature information and a target verification model to accordingly output a verification result.

According to one of the exemplary embodiments, the method for named entity verification model training includes to receive known type training data having training phrases with a target named entity type, to generate query phrases according to the training phrases, to perform auto-completion on each of the query phrases to receive returned phrases, to extract feature information from the returned phrases, and to train a target verification model associated with the target named entity type according to the feature information.

According to one of the exemplary embodiments, the method for phrase expansion includes to receive a phrase set from a phrase database, to generate a query phrases according to the phrase set, to perform auto-completion on each of the query phrases to receive returned phrases, to extract any new candidate phrase that does not exist in the phrase set from the returned phrases, to add the new candidate phrase to expand the phrase set, and to perform an iterative expansion control process to iteratively expand the phrase set based on the new candidate phrase.

According to one of the exemplary embodiments, the computer system includes a memory and at least one processor coupled to the memory. The memory is configured to store data and instructions. The processor is configured to access and execute the instructions to receive an unknown type phrase, to generate a query phrase according to the unknown type phrase, to perform auto-completion on the query phrase to receive one or more returned phrases, to extract feature information from the returned phrases, and to determine a named entity type of the unknown type phrase based on the feature information and a target verification model to accordingly output a verification result.

According to one of the exemplary embodiments, the computer system includes a memory and at least one processor coupled to the memory. The memory is configured to store data and instructions. The processor is configured to access and execute the instructions to receive known type training data including training phrases with a target named entity type, to generate query phrases according to the training phrases, to perform auto-completion on each of the query phrases to receive returned phrases, to extract feature information from the returned phrases, and to train a target verification model associated with the target named entity type according to the feature information.

According to one of the exemplary embodiments, the computer system includes a memory and at least one processor coupled to the memory. The memory is configured to store data and instructions. The processor is configured to access and execute the instructions to receive a phrase set from a phrase database, to generate a query phrases according to the phrase set, to perform auto-completion on each of the query phrases to receive returned phrases, to extract any new candidate phrase that does not exist in the phrase set from the returned phrases, to add the new candidate phrase to expand the phrase set, and to perform an iterative expansion control process to iteratively expand the phrase set based on the new candidate phrase.

In order to make the aforementioned features and advantages of the disclosure comprehensible, preferred embodiments accompanied with figures are described in detail below. It is to be understood that both the foregoing general description and the following detailed description are exemplary, and are intended to provide further explanation of the disclosure as claimed.

It should be understood, however, that this summary may not contain all of the aspect and embodiments of the disclosure and is therefore not meant to be limiting or restrictive in any manner. Also the disclosure would include improvements and modifications which are obvious to one skilled in the art.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 illustrates a schematic block diagram of a proposed computer system in accordance with one of the exemplary embodiments of the disclosure.

FIG. 2 illustrates a proposed method for named entity verification in accordance with one of the exemplary embodiments of the disclosure.

FIG. 3 illustrates a schematic block diagram of another proposed computer system in accordance with one of the exemplary embodiments of the disclosure.

FIG. 4 illustrates a proposed method for named entity verification model training in accordance with one of the exemplary embodiments of the disclosure.

FIG. 5 illustrates a schematic block diagram of another proposed computer system in accordance with one of the exemplary embodiments of the disclosure.

FIG. 6 illustrates a proposed method for phrase expansion in accordance with one of the exemplary embodiments of the disclosure.

FIG. 7A illustrates an application scenario of named entity verification in accordance with one of the exemplary embodiments of the disclosure.

FIG. 7B illustrates an application scenario of for named entity verification model training in accordance with one of the exemplary embodiments of the disclosure.

FIG. 7C illustrates an application scenario of phrase expansion in accordance with one of the exemplary embodiments of the disclosure.

FIG. 8 illustrates a schematic functional diagram of another proposed computer system in accordance with one of the exemplary embodiments of the disclosure.

To make the above features and advantages of the application more comprehensible, several embodiments accompanied with drawings are described in detail as follows.

### DESCRIPTION OF THE EMBODIMENTS

Some embodiments of the disclosure will now be described more fully hereinafter with reference to the accompanying drawings, in which some, but not all embodiments of the application are shown. Indeed, various embodiments of the disclosure may be embodied in many different forms and should not be construed as limited to the embodiments set forth herein; rather, these embodiments are provided so that this disclosure will satisfy applicable legal requirements. Like reference numerals refer to like elements throughout.

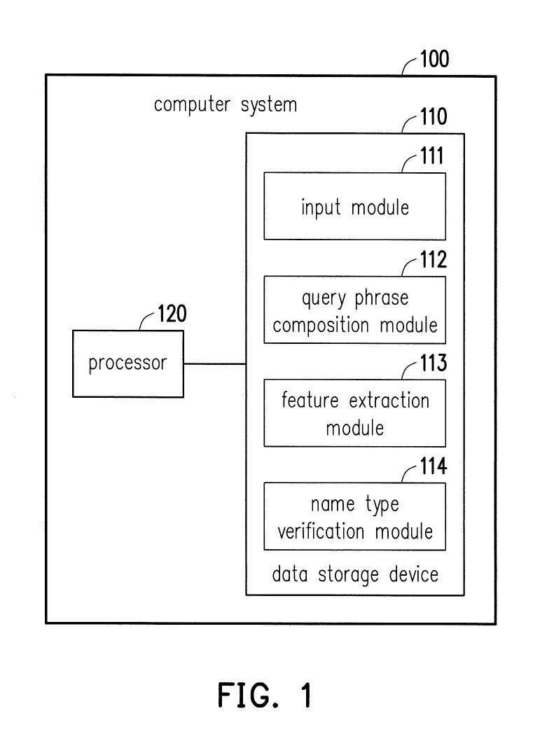

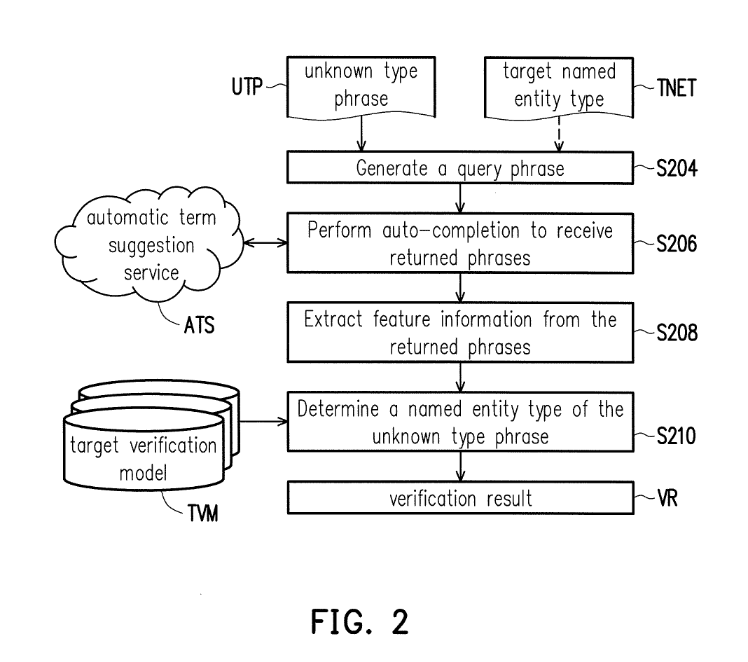

FIG. 1 illustrates a schematic diagram of a proposed computer system in accordance with one of the exemplary embodiments of the disclosure. All components of the computer system and their configurations are first introduced in FIG. 1. The functionalities of the components are disclosed in more detail in conjunction with FIG. 2.

Referring to FIG. 1, a computer system 100 at least includes a data storage device 110 and at least one processor 120, where the processor 120 is coupled to the data storage device 110. The computer system 100 may be an application server, a cloud server, a database server, a work station, or another suitable type of a computing system. The computer system 100 could also be a laptop computer, a tablet computer, a desktop computer, a smart phone, a personal digital assistant, or another suitable type of electronic device with processing capabilities.

The data storage device 110 may be one or a combination of a stationary or mobile random access memory (RAM), a read-only memory (ROM), a flash memory, a hard drive or other various forms of non-transitory, volatile, and non-volatile memories. The data storage device 110 is configured to store data, computer-readable and computer-executable instructions to implement various operations by the computer system 100.

The processor 120 may be one or a combination of a central processing unit (CPU), a programmable general purpose or special purpose microprocessor, a digital signal processor (DSP), an application specific integrated circuit (ASIC), a programmable logic device (PLD), a North Bridge, a South Bridge, a field programmable array (FPGA), or other similar device. The processor 120 is configured to access and execute instructions stored in the data storage device 110 in conjunction with or in response to information received from other devices connected to the computer system 100 or peripherals of the computer system 100 such as input/output devices, ports, and network interfaces, and so forth.

In the present exemplary embodiment, the instructions stored in the data storage device may be structured in a form of program modules including an input module 111, a query phrase composition module 112, a feature extraction module 113, and a name type verification module 114. A more detailed description on these modules follows below with reference to FIG. 2.

FIG. 2 illustrates a proposed method for named entity verification in accordance with one of the exemplary embodiments of the disclosure. The steps of FIG. 2 could be implemented by the proposed computer system 100 as illustrated in FIG. 1.

Referring to FIG. 2 in conjunction with FIG. 1, the input module 111 first receives an unknown type phrase UTP and a target named entity type TNET. The unknown type phrase UTP and the target named entity type TNET may be both manually input by the user through a user device or an I/O device. In some instances, the unknown type phrase UTP may be extracted from a given text segment or crawled from the web or other external databases, and the target named entity type TNET may be generated from a set of named entity types pre-stored in the data storage device 110 to perform a completely automatic named entity verification process. Also, the input module 111 may filter out stop words such as pronouns, articles, prepositions, conjunctions, adverbs from the unknown type phrase UTP as a pre-processing step.

In one exemplary embodiment, upon receiving the unknown type phrase UTP and the target named entity type TNET, the input module 111 may determine a language or a geographical region in associated with the unknown type phrase UTP as auxiliary information to improve the accuracy of verification. The input module 111 may determine the language of the unknown type phrase UTP based on its contextual content or user selection. The input module 111 may also determine the geographical region based on an IP address or user setting of the user device or an original source of the text segment that provides the unknown type phrase UTP and associate a regional language used in the determined geographical region.

For example, when the input module 111 extracts the term “die” from a German document, such term defined as a German article for feminine gender would be dropped from the unknown type phrase UTP. On the other hand, when the input module 111 extracts the term “die” from an English document, such term would be included in the unknown type phrase UTP since it is not categorized as a stop word in English and has various meanings depending on its context.

As another example, when the input module 111 extracts the term “Alcatraz Island” from a user input and determines that the geographical region of the user is in Taiwan, the term “Alcatraz Island” would be related to a restaurant. When the input module 111 extracts the term “Alcatraz Island” from a user input and determines that the geographical region of the user is in California, the term “Alcatraz Island” would be related to a national park. Such distinction would be especially beneficial in later steps.

Next, the query phrase composition module 112 generates a query phrase according to the unknown type phrase (Step S204). The query phrase may be the unknown type phrase UTP itself, a string extraction or a string concatenation of the unknown type phrase UTP. For example, in the case of string extraction, when the unknown type phrase UTP is “Captain America 2”, one possible query phrase may be a subset of “Captain America 2” such as “Captain America”. In the case of string concatenation, when the unknown type phrase UTP is “Captain America”, possible query phrases may be “Captain America” with a whitespace character at the end (i.e. “Captain America”), “Captain America” with a whitespace character and a numeric character at the end (e.g. “Captain America 2” and “Captain America 3”), and so forth.

Moreover, the query phrase may also be a combination of the unknown type phrase UTP and key phrases of the target named entity type TNET. The key phrases of the target named entity type TNET may be predefined and stored in the data storage device 110. For example, the key phrases for a movie named entity may be “movie”, “review”, “theatre”, “trailer”, “online”, “spoiler”, and etc. When the unknown type phrase UTP is “Captain America” and the target named entity type TNET is “movie”, the query phrases may be “Captain America”, one or more key phrases for movie, and a white space there between such as “movie Captain America”, “Captain America review”, “movie Captain America trailer”, and etc.

Once the query phrase is generated, the query phrase composition module 112 performs auto-completion on the query phrase to receive one or more returned phrases (Step S206). For illustrative purposes, the returned phrases herein would be in the plural hereafter. Auto-completion is an automatic term suggestion service ATS that may be supported by a web search engine such as Google, Yahoo, Bing, Baidu or any other search databases for interactive information retrieval. It should be noted that, different languages or geographical regions may result in different returned phrases. For example, when the geographical region is determined to be in Taiwan, the returned phrases of the query phrase “Batman v Superman” are “Batman v Superman Dawn of Justice”, “Batman v Superman Dawn of Justice Easter eggs”, “Batman v Superman Dawn of Justice review”, “Batman v Superman Easter eggs”, “Batman v Superman Easter spoiler”, “Batman v Superman Dawn of Justice watch online”, “Batman v Superman Dawn of Justice ending”, “Batman v Superman Dawn of Justice duration”, “Batman v Superman Dawn of Justice ptt”, “Batman v Superman ending”. As another example, when the geographical region is determined to be in the U.S., the returned phrases of the query phrase “Batman v Superman” are “Batman v Superman Cast”, “Batman v Superman Full Movie”, and “Batman v Superman Rotten Tomatoes”.

Next, the feature extraction module 113 extracts feature information from the returned phrases (Step S208). The feature extraction module 113 may first obtain related phrases from the returned phrases by removing the query phrase therefrom. For example, the related phrases of the query phrase in Taiwan are “Batman v Superman” are “Dawn of Justice”, “Dawn of Justice Easter eggs”, “Dawn of Justice review”, “Easter eggs”, “Easter spoiler”, “Dawn of Justice watch online”, “Dawn of Justice ending”, “Dawn of Justice duration”, “Dawn of Justice ptt”, “ending”. Next, the feature extraction module 113 may obtain a certain number of representative base phrases in associated with the target named entity type TNET. In particular, for this example, the top 15 base phrases for a movie named entity may be “movie”, “watch online”, “review”, “bt”, “caption”, “qvod”, “download”, “ptt”, “online”, “ending”, “spoiler”, “wiki”, “dvd”, “cast”, “comment”. It should be noted that, the base phrases for each named entity type are pre-stored in the data storage device 110, and more details in this respect will be given later on.

The feature extraction module 113 may compare the related phrases extracted from the returned phrase and the base phrases so as to calculate a feature value with respect to the base phrases. Each feature value is associated with the existence of the corresponding base phrase and may be assigned to a binary value 0 or 1, where 0 represents the non-existence of the corresponding base phrase, and 1 represents the existence of the corresponding base phrase. In the previous example, the feature values fv with respect to each base phrase according to the returned phrase are fv(movie)=0, “fv(watch online)=1”, “fv(review)=1”, “fv(bt)=0”, “fv(caption)=0”, “fv(qvod)=0”, “fv(download)=0”, “fv(ptt)=1”, “fv(online)=0”, “fv(ending)=0”, “fv(spoiler)=1”, “fv(wiki)=0”, “fv(dvd)=0”, “fv(cast)=0”, “fv(comment)=0”. These feature values are considered as the aforesaid feature information. Next, the feature extraction module 113 may convert the feature values into a 15-dimensional feature vector (0, 1, 1, 0, 0, 0, 0, 1, 0, 0, 1, 0, 0, 0, 0).

Next, the name type verification module 114 determines a named entity type of the unknown type phrase UTP based on the feature information and a target verification model TVM (Step S210) and accordingly outputs a verification result VR. In detail, a verification model for each named entity type is built in a training stage and pre-stored in the data storage device 110. The name type verification module 114 may input the feature vector into the target verification model TVM corresponding to the target named entity type TNET and obtain the output of the target verification model as the verification result VR.

In one instance, the target verification model may be loosely built as a binary classifier based on a rule-based model according to the based phrases of the corresponding named entity type. For example, if the feature information indicates that any returned phrase of the target named entity type TNET is included in the set of the based phrases of the target named entity type TNET, the name type verification module 114 may verify that the unknown type phrase UTP belongs to the target named entity type TNET. Equivalently, if there exists any feature value equal to 1, the name type verification module 114 may verify that the unknown type phrase UTP belongs to the target named entity type TNET. Herein, when the unknown type phrase UTP belongs to the target named entity type TNET, the unknown type phrase UTP may be assigned a tag with the target named entity type TNET and stored in a named entity database in the data storage device 110 for future reference. On the other hand, when the unknown type phrase UTP does not belong to the target named entity type TNET, it may remain unknown. In such case, another target named entity type may be generated from the set of named entity types or input by the user, and the flow may return to Step S204 for another named entity verification process.

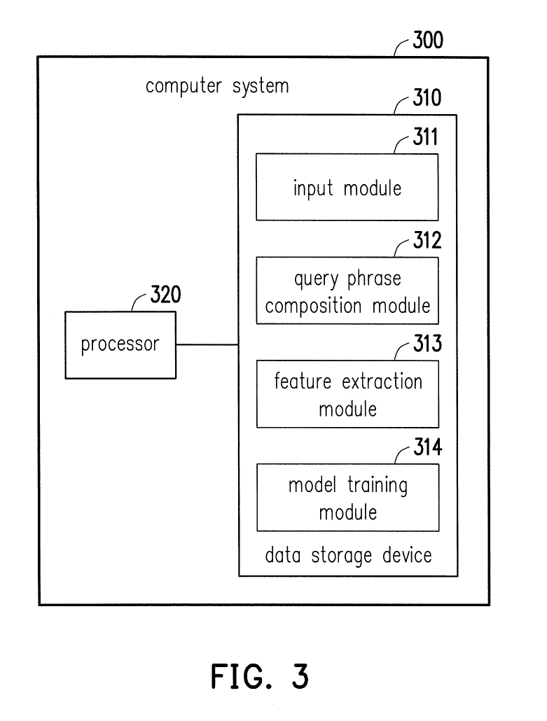

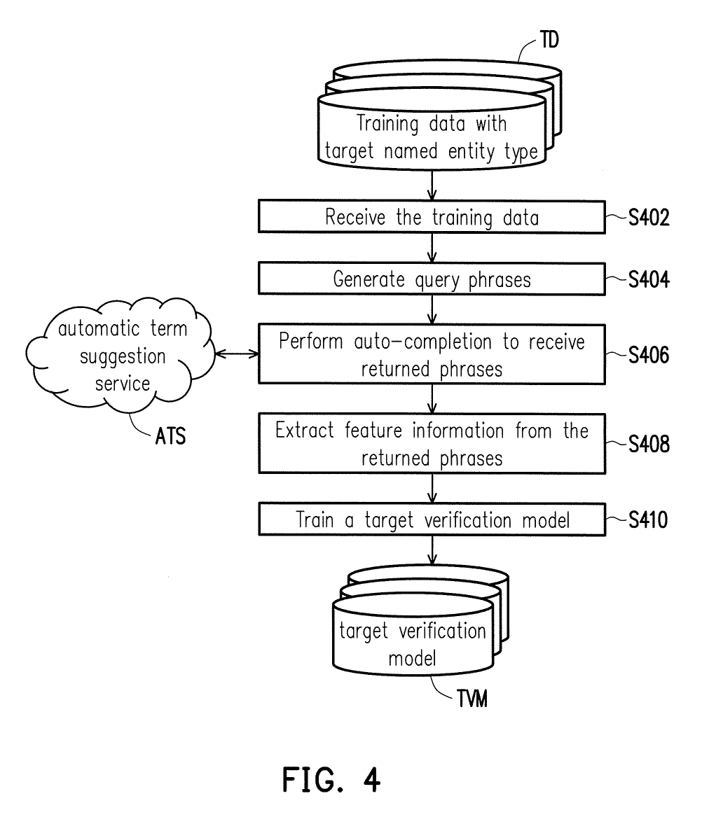

In another instance, the target verification model may be robustly built as a binary classifier or a multi-class classifier based on a machine learning model such as a support vector machine (SVM) model, a deep neural network (DNN) model, a multiplayer perceptron (MPL) neural network model. It should be noted that, in the multi-class classifier case, the input module 111 may receive multiple target named entity types (e.g. all pre-stored named entity types), and the name type verification module 114 may concurrently verify whether the unknown type phrase UTP belong to any of the target named entity types. Herein, the unknown type phrase UTP may be assigned a tag with the verified target named entity type and stored in a named entity database in the data storage device 110 for future reference. On the other hand, when the unknown type phrase UTP does not belong to any of the target named entity types, it may remain unknown. More details on how the target verification model is built and trained will be given below in conjunction with FIG. 3 and FIG. 4.

FIG. 3 illustrates a schematic block diagram of another proposed computer system in accordance with one of the exemplary embodiments of the disclosure.

Referring to FIG. 3, a computer system 300 at least includes a data storage device 310 and at least one processor 320, wherein similar components to FIG. 1 are designated with similar numbers having a “3” prefix.

In the present exemplary embodiment, the instructions stored in the data storage device may be structured in a form of program modules including an input module 311, a query phrase composition module 312, a feature extraction module 313, and a model training module 314. A more detailed description on these modules follows below with reference to FIG. 4.

FIG. 4 illustrates a proposed method for named entity verification model training in accordance with one of the exemplary embodiments of the disclosure. The steps of FIG. 4 could be implemented by the proposed computer system 300 as illustrated in FIG. 3.

Referring to FIG. 4 in conjunction with FIG. 3, the input module 311 first receives known type training data TD (Step S402). Herein, the known type training data TD includes a training data set having positive instances of training phrases with a target named entity type and negative instances of training phrases with other non-target named entity types. As an example in a movie named entity, the positive training phrases may be Chinese movie titles of all movies released in Taiwan between the years of 2010 and 2016. On the other hand, the negative training phrases may be restaurant names of top 100 popular restaurants in Taiwan or any other non-movie names. Also, upon receiving the known type training data TD, the input module 311 may determine a language or a geographical region to accordingly perform the later steps in a similar fashion as that described in FIG. 2.

Next, the query phrase composition module 312 generates query phrases according to the training phrases (Step S404). In the present exemplary embodiment, each query phrase may be a training phrase associated therewith or a training phrase with a whitespace. Once the query phrases are generated, the query phrase composition module 112 performs auto-completion individually on each query phrase through the automatic term suggestion service ATS to receive returned phrases (Step S406) as similar to Step S206.

In the present exemplary embodiment, the computer system 300 may further include a key phrase generating module (not shown) to generate multiple key phrases which are the elements for feature extraction and verification model construction in the later steps. Once the query phrase composition module 112 receives returned training phrases, the key phrase generating module selects a predetermined number of the most representative returned training phrases as the key phrases. In one instance, the key phrase generating module may obtain a rank list of the returned training phrases according to term frequency (TF) scores or term frequency-inverse document frequency (TF-IDF) scores which are well known per se and then select a predetermined number of returned training phrases from the rank list as the key phrases. For example, in a movie named entity, “movie”, “review”, and “watch online” may be the key phrases with the top 3 highest term frequencies, while in a restaurant named entity, “menu”, “dining review”, and “opening hours” may be the phrases with the top 3 highest term frequencies.

Next, the feature extraction module 313 extracts feature information from the returned phrase (Step S408), and the model training module 314 trains a target verification model associated with the target named entity type according to the feature information (Step S410), where the target verification model may be a supervised rule-based model or a supervised machine learning model and may be provided for the use in the steps of FIG. 2.

In the rule-based approach, the key phrases of the target named entity type may be simply considered as the feature information for training the target verification model. As an example in the movie named entity, the key phrases with the top 3 TF-IDF scores “movie”, “review”, and “watch online” may be considered as the feature information to training a movie verification model. The rule-based model may be particularly suitable for a binary classification.

In the machine learning approach, the feature extraction module 313 may first obtain the key phrases with the top 15 TF scores of the target named entity type as well as one or more non-target named entity types as base phrases. Assume that the training data includes a movie named entity, a restaurant named entity, and a TV show named entity, and yet it is possibly that the number of the base phrases is less than 45 (e.g. 38) since there may exist repeating key phrases among different named entity types. All the base phrases may be concatenated to form a vector base (e.g. a 38-dim vector base). Next, the feature extraction module 313 may obtain related phrases from the returned phrases by removing the query phrase therefrom and compare the related phrases extracted from the returned phrase and the vector base so as to calculate feature values with respect to all the base phrases, where the feature values form a feature vector. Each feature value is associated with the existence of the corresponding base phrase and may be assigned to a binary value 0 or 1, where 0 represents the non-existence of the corresponding base phrase, and 1 represents the existence of the corresponding base phrase. Next, the model training module 314 may use the feature vectors of all the training data to train the target verification model built based on a machine learning model such as a support vector machine (SVM) model, a deep neural network (DNN) model, a multiplayer perceptron (MPL) neural network model. The machine learning model may be suitable for a binary classification as well as a multi-class classification.

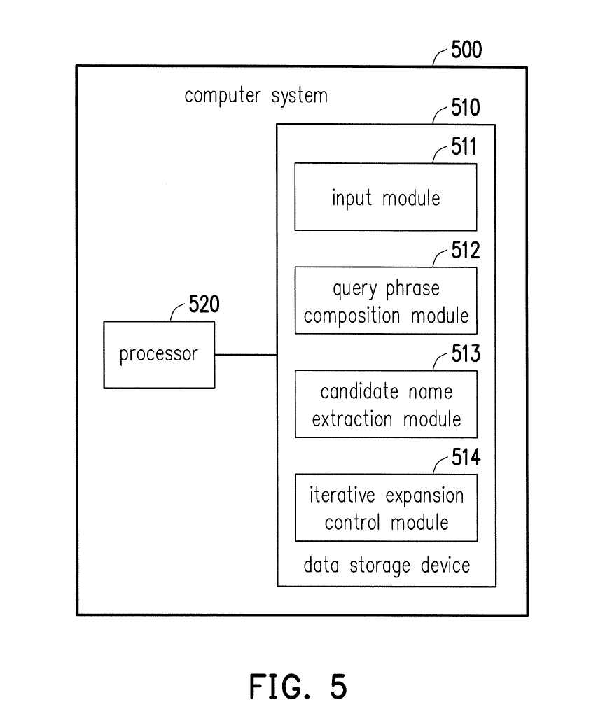

Many phrases have been created or evolved from time to time, and therefore new named entities may be constantly crawled to update the existing phrase database. Herein, FIG. 5 illustrates a schematic diagram of a proposed computer system in accordance with one of the exemplary embodiments of the disclosure.

Referring to FIG. 5, a computer system 500 at least includes a data storage device 3510 and at least one processor 520, wherein similar components to FIG. 1 are designated with similar numbers having a “5” prefix.

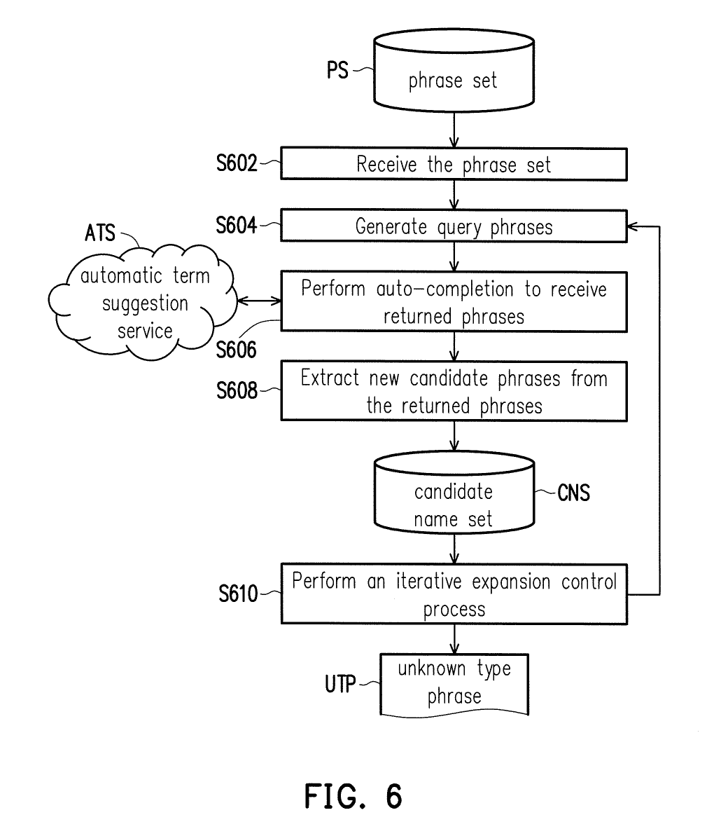

In the present exemplary embodiment, the instructions stored in the data storage device may be structured in a form of program modules including an input module 511, a query phrase composition module 512, a candidate name extraction module 513, and an iterative expansion control module 514. A more detailed description on these modules follows below with reference to FIG. 6.

FIG. 6 illustrates a proposed method for phrase expansion in accordance with one of the exemplary embodiments of the disclosure. The steps of FIG. 6 could be implemented by the proposed computer system 500 as illustrated in FIG. 5.

Referring to FIG. 6 in conjunction with FIG. 5, the input module 511 first receives a phrase set PS (Step S602), where the originality of the phrase set PS may be a basic dictionary. Also, upon receiving the phrase set PS, the input module 511 may determine a language or a geographical region to accordingly perform the later steps in a similar fashion as that described in FIG. 2. Next, the query phrase composition module 512 generates query phrases according to the phrase set PS (Step S604). The query phrases may be each phrase in the phrase set PS, a string extraction or a string concatenation of each phrase in the phrase set PS, or even a combination of each phrase and its key phrases as described in the previous exemplary embodiments.

In one exemplary embodiment, the input module 511 may receive a maximum phrase length set by the user or by system default, and the query phrase composition module 512 may limit the length of each of the query phrases not to exceed the maximum phrase length. The maximum phrase length may be set depending on the nature of the language. A typical query phrase is normally formed by at most 5 characters in Chinese and at most 8 characters in English, and thus the user may set the maximum phrase length between 1-5 for Chinese and between 1-8 for English.

In one exemplary embodiment, the input module 511 may receive a maximum phrase number set by the user or by system default, and the query phrase composition module 512 may limit the number of phrases each of the query phrases not to exceed the maximum phrase number to avoid redundancy.

Next, the candidate name extraction module 513 extracts new candidate phrases from the returned phrases (Step S608) and adds each into a candidate name set CN to expand the phrase set PS. In other words, the expanded phrase set may be considered as a combination of the original phrase set PS and the candidate name set CN including the new candidate phrases crawled from auto-completion. For example, assume the query phrase is “superman batman watch online”. If the phrases “Batman v Superman” and “Dawn of Justice” in the returned phrases do not exist in the phrase set PS and the candidate name set CN, the candidate name extraction module 513 may set these two phrases as new candidate phrases.

The iterative expansion control module 514 next performs an iterative expansion control process (Step S610) to iteratively expand the phrase set PS based on the new candidate phrases by recursively looping through Steps S604-S608. That is, the new candidate phrases may become the new query phrases for auto-completion. In one exemplary embodiment, the iterative expansion control module 514 may terminate the iterative expansion control process when no more new candidate phrase is received. On the other hand, the new candidate phrases are considered as unknown type phrases UTP, and the named entity types of the new candidate phrases may be verified or classified by the computer system 100 according to the flow in FIG. 2.

For a better comprehension of the aforementioned exemplary embodiments, several application scenarios and implementation will be described hereinafter.

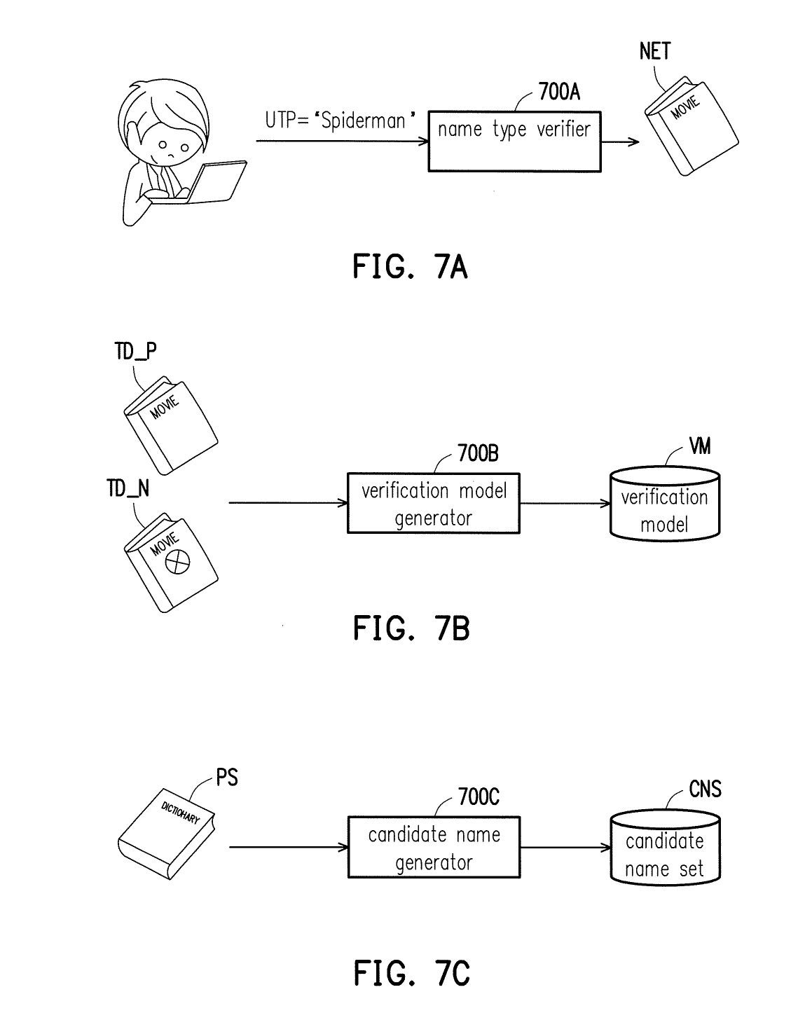

FIG. 7A illustrates an application scenario of named entity verification in accordance with one of the exemplary embodiments of the disclosure. In the present exemplary embodiment, a name type verifier 700A may receive a unknown type phrase UTP=“Spiderman” from the user and determine that the unknown type phrase is a movie named entity, where the name type verifier 700A may be implemented by the computer system 100 as illustrated in FIG. 1.

FIG. 7B illustrates an application scenario of training a named entity verification model in accordance with one of the exemplary embodiments of the disclosure. In the present exemplary embodiment, a verification model generator 700B may receive movie training phrases TD_P and non-movie training phrases TD_N to train a verification model VM accordingly, where the verification model generator 700B may be implemented by the computer system 300 as illustrated in FIG. 3.

FIG. 7C illustrates an application scenario of phrase expansion in accordance with one of the exemplary embodiments of the disclosure. In the present exemplary embodiment, a candidate name generator 700C may receive a phrase set PS such as a basic dictionary to constantly crawl and add new candidate phrases to a candidate name set CN, where the candidate name generator 700C may be implemented by the computer system 500 as illustrated in FIG. 5.

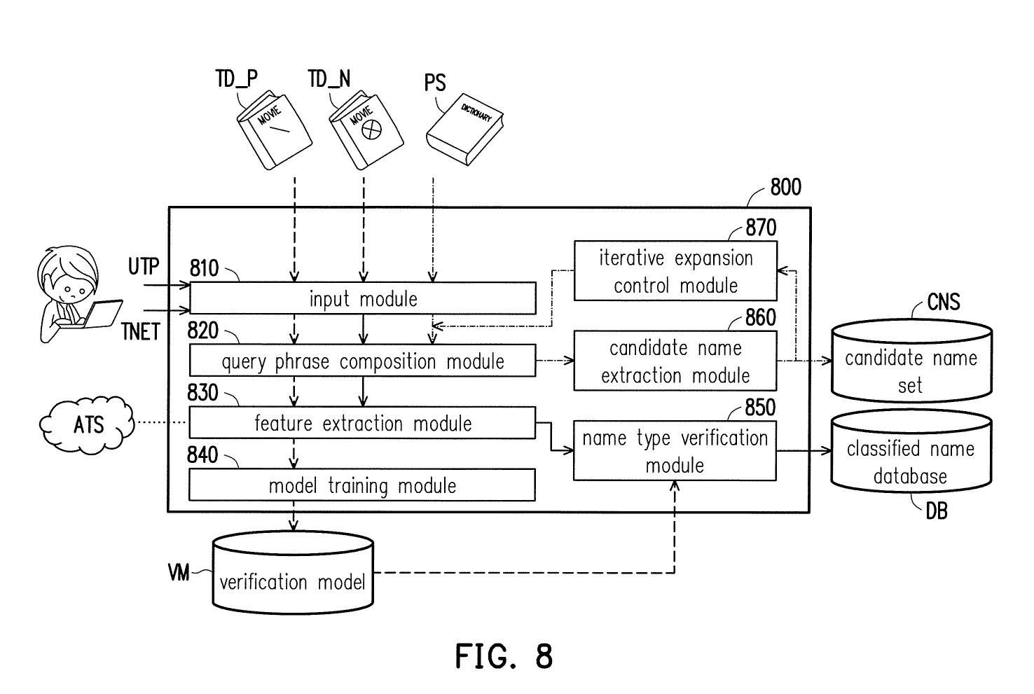

FIG. 8 illustrates a schematic functional diagram of another proposed computer system in accordance with one of the exemplary embodiments of the disclosure, where the proposed computer system herein may be viewed as an integration of the computer systems 100, 300, and 500.

Referring to FIG. 8, in a named entity verification stage, an input module 810 of a computer system 800 receives an unknown type phrase UTP and a target named entity type TNET from a user input. The query phrase composition module 820 generates query phrases according to the unknown type phrase UTP and the named entity type TNET and performs auto-completion individually on each query phrase to receive returned phrases. The feature extraction module 830 extracts feature information from the returned phrase, and the name type verification module 850 verifies whether or not the unknown type phrase belongs to the target named entity type based on the feature information and a verification model VM to accordingly output a verification result into a classified name database DB.

In a verification model training stage, an input module 810 of a computer system 800 receives training data including target training phrases TD_P and non-target training phrases TD_N. The query phrase composition module 820 generates query phrases according to the training data and performs auto-completion individually on each query phrase to receive returned phrases. The feature extraction module 830 extracts feature information from the returned phrase, and the model training module 840 trains the verification model VM according to the feature information.

In a phrase expansion stage, an input module 810 of a computer system 800 receives a phrase set PS such as a basic dictionary. The query phrase composition module 820 generates query phrases according to the phrase set PS and performs auto-completion individually on each query phrase to receive returned phrases. A candidate name extraction module 860 extracts new candidate phrases from the returned phrases and save those into a candidate name set CNS. Also, the iterative expansion control module 870 performs an iterative expansion control process to crawl new candidate phrases. Detailed steps of the three stages may refer to descriptions in the previous exemplary embodiments and are not be repeated for brevity purposes.

In view of the aforementioned descriptions, the disclosure is able to provide named entity verification on an unknown type phrase based on a verification model as well as to explore new named entity phrases on a constant basis with minimal human involvement and no necessity of language-dependent contextual information. The disclosure not only offloads the developers from deploying, configuring, and maintaining the related systems or infrastructure, but also supports different languages used in different geographical regions that deliver solutions on a global scale.

No element, act, or instruction used in the detailed description of disclosed embodiments of the present application should be construed as absolutely critical or essential to the present disclosure unless explicitly described as such. Also, as used herein, each of the indefinite articles “a” and “an” could include more than one item. If only one item is intended, the terms “a single” or similar languages would be used. Furthermore, the terms “any of” followed by a listing of a plurality of items and/or a plurality of categories of items, as used herein, are intended to include “any of”, “any combination of”, “any multiple of”, and/or “any combination of multiples of the items and/or the categories of items, individually or in conjunction with other items and/or other categories of items. Further, as used herein, the term “set” is intended to include any number of items, including zero. Further, as used herein, the term “number” is intended to include any number, including zero.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. A computer-implemented method for named entity verification comprising:
receiving an unknown type phrase;
generating a query phrase according to the unknown type phrase;
performing auto-completion on the query phrase to receive at least one returned phrase;
extracting feature information from the at least one returned phrase; and
determining a named entity type of the unknown type phrase based on the feature information and a target verification model to accordingly output a verification result.

2. The method according to claim 1, wherein the step of generating the query phrase according to the unknown type phrase comprises:
generating the query phrase according to a string extraction or a string concatenation of the unknown type phrase.

3. The method according to claim 1, wherein before the step of generating the query phrase according to the unknown type phrase, the method further comprises:
receiving a target named entity type.

4. The method according to claim 3, wherein the target named entity type is received from a user input or selected from a set of pre-stored named entity types.

5. The method according to claim 3, wherein the step of generating the query phrase according to the unknown type phrase comprises:
generating the query phrase according to the unknown type phrase and at least one key phrase of the target named entity type.

6. The method according to claim 3, wherein the step of determining the named entity type of the unknown type phrase based on the feature information and the target verification model to accordingly output the verification result comprises:
determining whether or not the unknown type phrase belongs to the target named entity type based on the feature information and the target verification model to accordingly output the verification result.

7. The method according to claim 6, wherein the step of extracting the feature information from the at least one returned phrase comprises:
obtaining and setting at least one related phrase from the at least one returned phrase as the feature information.

8. The method according to claim 7, wherein the target verification model is a supervised rule-based model, and wherein the step of determining whether or not the unknown type phrase belongs to the target named entity type based on the feature information and the target verification model to accordingly output the verification result comprises:
obtaining a plurality of base phrases in associated with the target named entity type;
inputting the feature information into the target verification model; and
obtaining the verification result from an output of the target verification model, wherein the output is associated with an existence of any of the base phrases within the at least one related phrase and indicates whether or not the unknown type phrase belongs to the target named entity type.

9. The method according to claim 6, wherein the step of extracting the feature information from the at least one returned phrase comprises:
obtaining at least one related phrase from the at least one returned phrase;
obtaining a plurality of base phrases in associated with the target named entity type;
calculating a plurality of feature values according to the at least one related phrase and the base phrases, wherein each of the feature values is a binary value and determined by whether there exists each of the base phrases within the at least one related phrase; and
converting the feature values to a feature vector as the feature information.

10. The method according to claim 9, wherein the target verification model is a supervised machine learning model, and wherein the step of determining whether or not the unknown type phrase belongs to the target named entity type based on the feature information and the target verification model to accordingly output the verification result comprises:
inputting the feature vector into the target verification model; and obtaining the verification result from an output of the target verification model, wherein the output indicates whether or not the unknown type phrase belongs to the target named entity type or indicates that the unknown type phrase belongs to any of the named entity types.

11. The method according to claim 1, wherein after the step of receiving the unknown type phrase and the target named entity type, the method further comprises:
determining a language or a geographical region in associated with the unknown type phrase so as to accordingly generate the at least one query phrase and extract the feature information from the at least one returned phrase.

12. A computer-implemented method for training a named entity verification model comprising:
receiving known type training data, wherein the known type training data comprises a plurality of training phrases with a target named entity type;
generating a plurality of query phrases according to the training phrases;
performing auto-completion on each of the query phrases to receive a plurality of returned phrases;
extracting feature information from the returned phrases corresponding to each of the query phrases; and
training a target verification model associated with the target named entity type according to the feature information.

13. The method according to claim 12, wherein the step of generating the query phrases according to the training phrases comprises:
setting each of the training phrases or each of the training phrases with a whitespace character as the query phrases.

14. The method according to claim 12 further comprising:
generating a plurality of key phrases from the returned phrases corresponding to a target named entity type.

15. The method according to claim 14, wherein the step of generating the plurality of key phrases from the returned phrases corresponding to the target named entity type comprises:
obtaining a rank list of the returned phrases according to term frequency scores; and
selecting a predetermined number of returned phrases from the rank list as the plurality of key phrases.

16. The method according to claim 14, wherein the step of generating the plurality of key phrases from the returned phrases corresponding to the target named entity type comprises:
obtaining a rank list of the returned phrases according to term frequency-inverse document frequency scores; and
selecting a predetermined number of returned phrases from the rank list as the plurality of key phrases.

17. The method according to claim 14, wherein the steps of extracting the feature information from the returned phrases and training the target verification model associated with the target named entity type according to the feature information comprise:
obtaining the plurality of key phrases as the feature information in associated with the target named entity type; and
training the target verification model according to the feature information based on a supervised rule-based model.

18. The method according to claim 14, wherein the steps of extracting the feature information from the returned phrases and training the target verification model associated with the target named entity type according to the feature information comprise:
obtaining at least one related phrase from the returned phrases;
obtaining the plurality of key phrases as a plurality of base phrases in associated with the target named entity type;
calculating a plurality of feature values as the feature information according to the at least one related phrase and the base phrases; and
training the target verification model according to the feature information based on a supervised machine learning model.

19. The method according to claim 12, wherein the known type training data further comprises a plurality of other training phrases with a non-target named entity type to train the target verification model.

20. The method according to claim 12, wherein after the step of receiving the known type training data, the method further comprises:
determining a language or a geographical region in associated with the known type training data so as to accordingly generate the query phrases and extract the feature information from the returned phrases.

21. A method for phrase expansion comprising:
receiving a phrase set from a phrase database;
generating a plurality of query phrases according to the phrase set;
performing auto-completion on each of the query phrases to receive at least one returned phrase;
extracting a new candidate phrase from the at least one returned phrase, wherein the new candidate phrase does not exist in the phrase set;
adding the new candidate phrase to expand the phrase set; and
performing an iterative expansion control process to iteratively expand the phrase set based on the new candidate phrase.

22. The method according to claim 21 further comprising:
receiving a maximum phrase length; and
limiting the length of each of the query phrases not to exceed the maximum phrase length.

23. The method according to claim 21 further comprising:
receiving a maximum phrase number; and
limiting the number of phrases each of the query phrases not to exceed the maximum phrase number.

24. The method according to claim 21 further comprising:
terminating the iterative expansion control process when no new candidate phrase is received.

25. The method according to claim 21, wherein after the step of receiving the phrase set from the phrase database, the method further comprises:
determining a language or a geographical region in associated with the phrase set so as to accordingly receive the at least one returned phrase.

26. A computer system comprising:
a memory, configured to store data and a plurality of instructions;
at least one processor, coupled to the memory, and configured to access and execute the instructions to perform steps of:
receiving an unknown type phrase;
generating a query phrase according to the unknown type phrase;
performing auto-completion on the query phrase to receive at least one returned phrase;
extracting feature information from the at least one returned phrase; and
determining a named entity type of the unknown type phrase based on the feature information and a target verification model to accordingly output a verification result.

27. A computer system comprising:
a memory, configured to store data and a plurality of instructions;
at least one processor, coupled to the memory, and configured to access and execute the instructions to perform steps of:
receiving known type training data, wherein the known type training data comprises a plurality of training phrases with a target named entity type;
generating a plurality of query phrases according to the training phrases;
performing auto-completion on each of the query phrases to receive a plurality of returned phrases;
extracting feature information from the returned phrases corresponding to each of the query phrases; and
training a target verification model associated with the target named entity type according to the feature information.

28. A computer system comprising:
a memory, configured to store data and a plurality of instructions;
at least one processor, coupled to the memory, and configured to access and execute the instructions to perform steps of:
receiving a phrase set from a phrase database;
generating a plurality of query phrases according to the phrase set;
performing auto-completion on each of the query phrases to receive at least one returned phrase;
extracting a new candidate phrase from the at least one returned phrase, wherein the new candidate phrase does not exist in the phrase set;
adding the new candidate phrase to expand the phrase set; and
performing an iterative expansion control process to iteratively expand the phrase set based on the new candidate phrase.
